(19) United States
(12) Patent Application Publication
(10) Pub. No.: US 2023/0153137 A1
(43) Pub. Date: May 18, 2023

(54) REMOTE RENDERING SYSTEM, METHOD AND DEVICE BASED ON VIRTUAL MOBILE ARCHITECTURE

(71) Applicant: Industrial Technology Research Institute, Hsinchu (TW)

(72) Inventors: Ping-Hsien Chi, Taipei City (TW); Yi-Wen Li, Yunlin County (TW); Yun-Chen Tsai, Taipei City (TW); Chuan-Sheng Lin, Kaohsiung City (TW); Yu-Hsuan Chi, Taipei City (TW)

(73) Assignee: Industrial Technology Research Institute, Hsinchu (TW)

(21) Appl. No.: 17/558,590

(22) Filed: Dec. 22, 2021

(30) Foreign Application Priority Data
Nov. 16, 2021 (TW) 110142537

(51) Int. Cl. G06F 9/455; G06T 1/20; G06F 9/451; H04L 67/131; H04L 67/01

(52) U.S. Cl. CPC G06F 9/45533; G06F 9/452; G06T 1/20; H04L 67/38; H04L 67/42; G06F 2009/45595

(57) ABSTRACT

A remote rendering system based on a virtual mobile architecture, including a client and a server is provided. The client includes a central processing unit (CPU) for executing a remote rendering service receiver (RRS receiver) and applications, a graphics processing unit (GPU), and a display. The server is configured to execute a QEMU pipe and a remote rendering service sender (RRS sender). OpenGL commands are transmitted to the RRS sender through the QEMU pipe, and the RRS sender transmits the OpenGL commands to the client. The CPU executes the RRS receiver to receive the OpenGL commands. After a connection between the RRS receiver and the applications is established, the GPU draws a screen corresponding to the applications according to the OpenGL commands, and displays the screen through the monitor.

### CROSS-REFERENCE TO RELATED APPLICATION

This application claims the priority benefit of Taiwan application serial no. 110142537, filed on Nov. 16, 2021. The entirety of the above-mentioned patent application is hereby incorporated by reference herein and made a part of this specification.

### BACKGROUND

### Technical Field

The present disclosure relates to a rendering system, and in particular to a remote rendering system, method, and device based on a virtual mobile architecture.

### Description of Related Art

In a current solution of a virtual mobile architecture (VMI) (for example: Android VMI), user experience is an important factor that leads to success or failure of a product. If the VMI may provide a use environment that is more similar to the user’s physical machine, it will be more easily accepted by the user, and the success rate of the product will be higher.

FIG. 1 is a schematic diagram of a conventional remote rendering system 1′ based on a virtual mobile architecture. Referring to FIG. 1, in the current Android VMI solution, the Android virtual machine configured on a server 100 is used to generate OpenGL commands corresponding to an application 201 in a client 200 through an emulation (for example: an emulation EGL 101) with an image. After an QEMU pipe 102 captures the OpenGL commands, the OpenGL commands are successively transmitted to an open graphics library (OpenGL) 103. A graphics processing unit (GPU) 104 draws an image based on the OpenGL commands by using a translator (for example: a translator EGL 105) according to the OpenGL 103 to generate screen imaging. After screen imaging is generated, the image is encoded, and then the encoded image is packaged. The image package is transmitted to the client 200 through an Internet 300. After the client 200 receives the image package, the image package is transmitted to the application 201 in the client 200. The image package is decoded according to the OpenGL 103, and then transmitted to an OpenGL 202. An image corresponding to the application 201 is drawn at the client 200, and screen imaging is generated.

In a conventional rendering mechanism as described above, time is mainly spent on the following. The Android virtual machine must perform rendering first, and then a screen is encoded and compressed for transmission; after an remote apparatus receives data, the picture must be decoded before the screen is displayed on the Android Surface. Soft decoding has poor performance and technical bottlenecks. Therefore, user experience partly depends on a current Internet speed and performance of the Android virtual machine. If the Internet environment or computing performance is not good, the resolution is reduced to maintain a fixed frames per second. However, this method negatively affects user experience and greatly affects users’ willingness to use the product. Transmitting encoded and compressed images through the Internet occupies a high Internet bandwidth, resulting in an increase in Internet traffic for users.

### SUMMARY

A remote rendering system based on a virtual mobile architecture provided by the present disclosure includes a client and a server. The client includes a central processing unit, a graphics processing unit (GPU), and a display. The central processing unit is used to execute a remote rendering service receiver (RRS receiver) and an application. The graphics processing unit (GPU) is coupled to the central processing unit. The display is coupled to the graphics processing unit. The server connects to the client through an Internet communication protocol to execute a QEMU pipe and a remote rendering service sender (RRS sender). Multiple OpenGL commands are transmitted to the remote rendering service sender through the QEMU pipe, and the remote rendering service sender transmits the OpenGL commands to the client. The central processing unit executes the remote rendering service receiver to receive the OpenGL commands. After a connection between the remote rendering service receiver and the application is established, the graphics processing unit draws a screen corresponding to the application according to the OpenGL commands, and displays the screen through the display.

A remote rendering method based on a virtual mobile architecture provided by the present disclosure includes the following. OpenGL commands are transmitted to a remote rendering service sender through a QEMU pipe. The remote rendering service sender transmits the OpenGL commands to a client through an Internet communication protocol. The client executes a remote rendering service receiver to receive the OpenGL commands. After a connection between the remote rendering service receiver and an application is established, a screen corresponding to the application is drawn according to the OpenGL commands. The screen is displayed at the client.

A remote rendering device based on a virtual mobile architecture provided by the present disclosure includes a central processing unit, a graphics processing unit, and a display. The central processing unit is used to execute a remote rendering service receiver to receive multiple OpenGL commands from a server. The graphics processing unit is coupled to the central processing unit, and is used to draw a screen corresponding to the application according to the OpenGL commands after a connection between the remote rendering service receiver and the application has been established. The display is coupled to the graphics processing unit to display the screen.

### BRIEF DESCRIPTION OF THE DRAWINGS

FIG. 1 is a schematic diagram of a conventional remote rendering system based on a virtual mobile architecture.

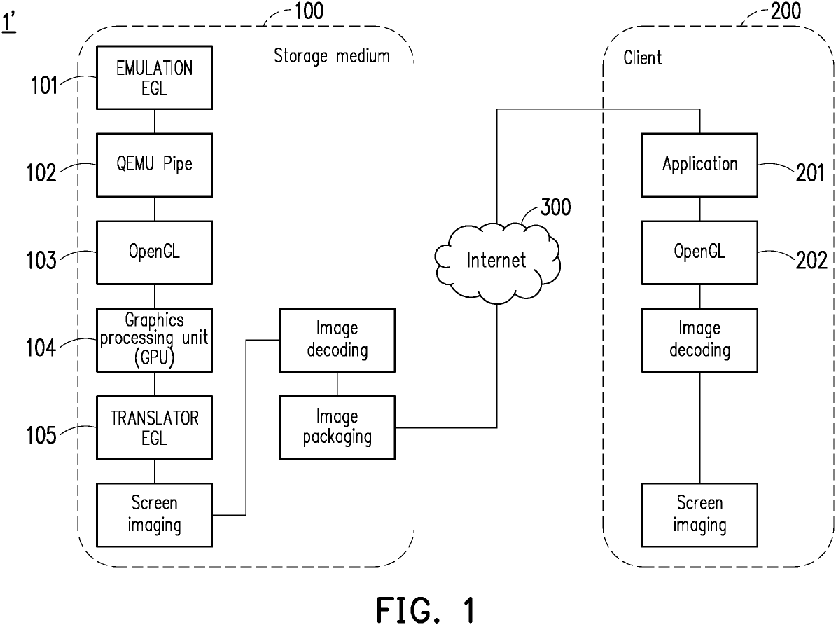

FIG. 2 illustrates a schematic diagram of a remote rendering system based on a virtual mobile architecture according to an embodiment of the present disclosure.

FIG. 3 illustrates a flow chart of a remote rendering method based on a virtual mobile architecture according to an embodiment of the present disclosure.

### DESCRIPTION OF THE EMBODIMENTS

A portion of the embodiments of the present disclosure will be described in detail in connection with the accompanying drawings. The reference numerals cited in the following description will be regarded as the same or similar elements when the same reference numerals appear in different drawings. These embodiments are only part of the present disclosure and do not disclose all the methods that may be implemented in the present disclosure.

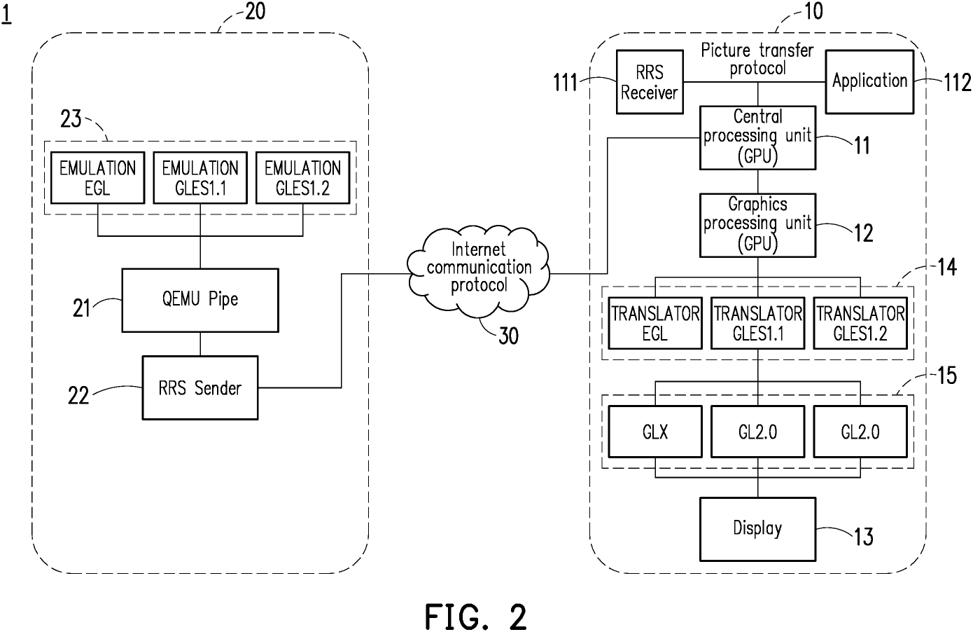

FIG. 2 illustrates a schematic diagram of a remote rendering system 1 based on a virtual mobile architecture according to an embodiment of the present disclosure. Referring to FIG. 2, the remote rendering system 1 based on a virtual mobile architecture includes a client 10 and a server 20. The client 10 includes a central processing unit 11, a graphics processing unit (GPU) 12, and a display 13. In practice, the client 10 is an electronic device such as a tablet computer or a smartphone that may connect to the server 20 through an Internet communication protocol 30, and the present disclosure is not limited thereto.

The central processing unit 11 is used to execute a remote rendering service receiver (RRS Receiver) 111 and an application 112. The application 112 described in the present disclosure may be, for example, an application that needs to be connected to the server 20 through the Internet communication protocol 30 for rendering, for example, a game application that connects to a game server to connect to a game. The client 10 must first obtain the authentication of the server 20. After the client 10 passes the authentication, the virtual machine of the server 20 generates a corresponding OpenGL command according to an operation command of the client 10, and then the OpenGL command is transmitted back to the client 10. After the client 10 receives the OpenGL command, the client 10 executes the remote rendering service receiver 111 to start the rendering operation. In practice, the central processing unit 11 may be a micro-processor or an embedded controller, and the present disclosure is not limited thereto. The remote rendering service receiver 111 and the application 112 may be stored in a storage device (not shown in the drawings) of the client 10 to be accessed by the central processing unit 11.

The graphics processing unit 12 is coupled to the central processing unit 11 to execute graphics operations. In practice, the GPU 12 may be individually combined with a dedicated circuit board and auxiliary components to form a graphics card, directly embedded on the motherboard as a single chip, built into a north bridge chip of the motherboard, or built on the CPU to form a single chip. The display 13 is coupled to the graphics processing unit 12. In practice, the display 13 may be a display panel on a personal mobile device such as a tablet or smartphone, or an external display device of a personal mobile device.

The server 20 connects to the client 10 through the Internet communication protocol 30 to execute an QEMU pipe 21 and a remote rendering service sender (RRS sender) 22. The QEMU Pipe 21 and the RRS sender 22 are stored in a storage device of server 20 (not shown in the drawings). The storage device of the server 20 further stores an emulation 23. The emulation 23 includes Emulation EGL, Emulation GLES 1.1, and Emulation GLES 1.2. It should be noted that an emulator included in the server in the conventional remote rendering system is also included in the remote rendering service sender 22 shown in the present disclosure.

The virtual machine of the server 20 generates corresponding OpenGL commands through the emulation 23 according to the operation command of the client 10. The server 20 collects an EGL/GLES function call sequence and converts the same into a customized transmission protocol. The OpenGL commands are transmitted to the remote rendering service sender 22 through the QEMU pipe 21. The QEMU pipe 21 is a high-speed transmission channel, which may transmit the OpenGL commands at a high speed for efficient reading and writing. The server 20 transmits the OpenGL commands to the client 10 through the Internet communication protocol 30.

After the client 10 receives the OpenGL commands, the central processing unit 11 executes the remote rendering service receiver 111 to receive the OpenGL commands to execute rendering. When a connection is established between the remote rendering service receiver 111 and the application 112, the graphics processing unit 12 draws a screen corresponding to the application 112 according to the OpenGL commands, and displays the screen through the display 13.

The storage device of client 10 further stores a translator 14. The translator 14 corresponds to the emulation 23 in the server 20, and includes Translator EGL, Translator GLES 1.1, and Translator GLES 1.2. The OpenGL commands are generated by one of Emulation EGL, Emulation GLES 1.1, and Emulation GLES 1.2 in the emulation 23 in the server 20. The graphics processing unit 12 uses the corresponding translator 14 to parse the OpenGL commands, transmits the OpenGL commands to one of GLX and GL2.0 in the corresponding OpenGL 15, draws a screen corresponding to the application 112, and displays the screen through the display 13.

In an embodiment, after the client 10 obtains the authentication of the server 20, the server 20 establishes an Internet communication protocol with the client 10, and establishes a picture transfer protocol between the remote rendering service receiver 111 and the application 112 in the client 10. The Internet communication protocol 30 (for example, WebSocket communication protocol) is a communication protocol mainly for the transmission of OpenGL commands from the server 20 to the client 10 via the Internet. In an embodiment, the central processing unit 11 executes the remote rendering service receiver 111 according to the Internet communication protocol to receive the OpenGL commands. The picture transfer protocol is a transfer protocol mainly for the remote rendering service receiver 111 to execute rendering on the application 112 after receiving the OpenGL commands and for the remote rendering service receiver 111 to read the response of the application 112.

In an embodiment, the client 10 includes a buffer (not shown in the drawings). When the remote rendering service sender 22 transmits the OpenGL commands to the client 10, in order to ensure that client 10 may execute rendering operations correctly and instantly, the server 20 confirms whether there are data in the buffer through the Internet communication protocol 30. If the server 20 confirms that there are no data in the buffer, it means that the client 10 did not successfully receive the OpenGL commands. If so, the remote rendering service sender 20 instructs the remote rendering service sender 22 to continuously send the OpenGL commands to the client 10, and the server 20 continuously confirms whether there are data in the buffer until the server 20 confirms that there are data in the buffer through the Internet communication protocol 30.

In an embodiment, if the server 20 confirms that there are data in the buffer, the server 20 confirms whether a connection between the remote rendering service receiver 111 and the application 112 has been established according to the picture transfer protocol. If the server 20 confirms that the connection between the remote rendering service receiver 111 and the application 112 has not been established, the server 20 re-establishes the connection between the remote rendering service receiver 111 and the application 112 according to the picture transfer protocol. If the server 20 confirms that the connection between the remote rendering service receiver 111 and the application 112 is established, the server 20 transmits the OpenGL commands to the client 10 according to the Internet communication protocol 30.

In an embodiment, the client 10 of the virtual mobile architecture provided by the present disclosure is a remote rendering device. The client 10 (remote rendering device) includes the central processing unit 11, the graphics processing unit (GPU) 12, and the display 13. In practice, the remote rendering device is, for example, an electronic device such as a tablet computer or a smartphone that may connect to the server 20 through the Internet communication protocol 30, and the present disclosure is not limited to this.

The central processing unit 11 is used to execute the remote rendering service receiver 111 to receive a plurality of OpenGL commands from the server 20 through the Internet communication protocol 30. The graphics processing unit 12 is coupled to the central processing unit 11, and is used to draw a screen corresponding to the application 112 according to the OpenGL commands after a connection is established between the remote rendering service receiver 111 and the application 112. The display 13 is coupled to the GPU 12 to display the screen. How the central processing unit 11, the GPU 12, and the display 13 are implemented in practice has been described above, so details thereof will not be repeated herein.

In an embodiment, the server 20 establishes an Internet communication protocol 30 with the central processing unit 11, and establishes a picture transfer protocol between the remote rendering service receiver 111 and the application 112. The central processing unit 11 executes the remote rendering service receiver 111 according to the Internet communication protocol 30 to receive OpenGL commands.

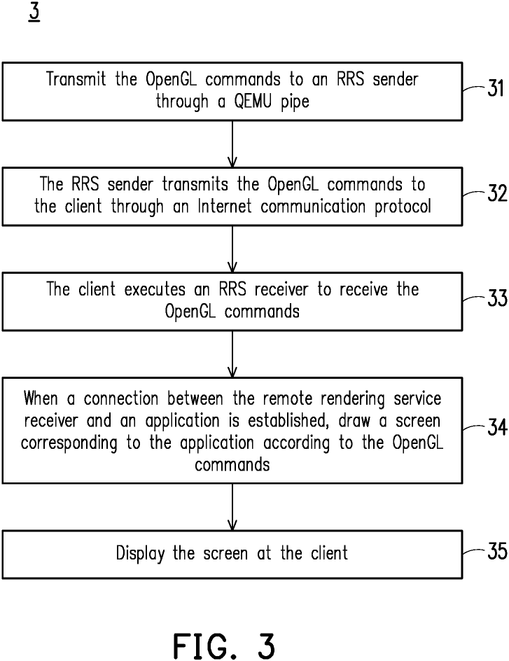

FIG. 3 illustrates a flow chart of a remote rendering method based on a virtual mobile architecture according to an embodiment of the present disclosure. Referring to FIG. 3, a virtual machine of a server generates corresponding OpenGL commands through an emulation according to an operation command of a client. The server collects an EGL/GLES function call sequence and converts the EGL/GLES function call sequence into a customized transmission protocol. In step 31, the OpenGL commands are transmitted to a remote rendering service sender through a QEMU pipe.

In step 32, the remote rendering service sender transmits the OpenGL commands to the client through an Internet communication protocol. After the client receives the OpenGL commands, in step 33, a remote rendering service receiver is executed by the client to receive the OpenGL commands and execute rendering. In step 34, when a connection between the remote rendering service receiver and an application is established, a screen corresponding to the application is drawn according to the OpenGL commands. In step 35, the screen is displayed at the client.

In an embodiment, before a virtual machine of the server generates the corresponding OpenGL commands through the emulation according to the operation command of the client, the server establishes an Internet communication protocol with the client, and establishes a picture transfer protocol between the remote rendering service receiver and the application.

In an embodiment, the client executes the RRS receiver according to the Internet communication protocol to receive the OpenGL commands. When transmitting the OpenGL commands to the client, the server confirms whether there are data in a buffer of the client through the Internet communication protocol. If the buffer confirms that there are no data in the server, the OpenGL commands are continuously transmitted, and it is continuously confirmed whether there are data in the buffer. Conversely, if the buffer confirms that there are data in the server, the server confirms whether a connection between the remote rendering service receiver and the application has been established according to the picture transfer protocol.

In an embodiment, if the server confirms that the connection between the remote rendering service receiver and the application has not been established, the client re-establishes the picture transfer protocol connecting the remote rendering service receiver and the application. If the server confirms that the connection between the remote rendering service receiver and the application has been established, the OpenGL commands are transmitted to the client according to the Internet communication protocol.

After the client 10 obtains the authentication from the server 20, the server 20 establishes the Internet communication protocol 30 with the client 10, and establishes the picture transfer protocol between the remote rendering service receiver 111 and the application 112 in the client 10. The Internet communication protocol 30 is a communication protocol for OpenGL commands to be transmitted from the server 20 to the client 10 via the Internet.

In summary, the remote rendering system, device, and method based on a virtual mobile architecture provided by the present disclosure are different from the conventional image rendering technology based on a virtual mobile architecture in that no encoding/decoding mechanism is required. In the remote rendering system, device, and method based on a virtual mobile architecture provided by the present disclosure, the OpenGL commands in the Android virtual machine are captured, the commands are obtained, the commands are transmitted to the remote apparatus via the Internet. Next, the remote apparatus imports the commands to the renderer, which assists in rendering the screen to the display of the remote device. By using this mechanism, the number of times of executing the OpenGL commands may be reduced to one time, Internet transmission traffic may be reduced, and user experience and operational smoothness may be improved. Furthermore, since the number of times of executing the OpenGL commands may be reduced to one time, the delay time when rendering the screen of the remote apparatus may be shortened, and the resolution of the rendering screen may be improved.

What is claimed is:

1. A remote rendering system based on a virtual mobile architecture, comprising:
a client, comprising:
a central processing unit, used to execute a remote rendering service receiver and an application;
a graphics processing unit, coupled to the central processing unit; and
a display, coupled to the graphics processing unit; and
a server, connecting to the client through an Internet communication protocol, used to execute a QEMU pipe and a remote rendering service sender, wherein a plurality of OpenGL commands are transmitted to the remote rendering service sender through the QEMU pipe, and the remote rendering service sender transmits the OpenGL commands to the client;
wherein the central processing unit executes the remote rendering service receiver to receive the OpenGL commands, and when a connection between the remote rendering service receiver and the application is established, the graphics processing unit draws a screen corresponding to the application according to the OpenGL commands, and displays the screen through the display.

2. The remote rendering system based on a virtual mobile architecture according to claim 1, wherein the server establishes the Internet communication protocol with the client, and establishes a picture transfer protocol between the remote rendering service receiver and the application.

3. The remote rendering system based on a virtual mobile architecture according to claim 2, wherein the central processing unit executes the remote rendering service receiver according to the Internet communication protocol to receive the OpenGL commands.

4. The remote rendering system based on a virtual mobile architecture according to claim 3, wherein the client comprises a buffer, when the remote rendering service sender transmits the OpenGL commands to the client, the server confirms whether there are data in the buffer through the Internet communication protocol, and if the server confirms that there are no data in the buffer, the remote rendering service sender continuously transmits the OpenGL commands to the client, and the server continuously confirms whether there are data in the buffer.

5. The remote rendering system based on a virtual mobile architecture according to claim 4, wherein if the server confirms that there are data in the buffer, the server confirms whether a connection between the remote rendering service receiver and the application has been established according to the picture transfer protocol.

6. The remote rendering system based on a virtual mobile architecture according to claim 5, wherein if the server confirms that the connection between the remote rendering service receiver and the application has not been established, the client re-establishes the connection between the remote rendering service receiver and the application according to the picture transfer protocol.

7. The remote rendering system based on a virtual mobile architecture according to claim 5, wherein if the server confirms that the connection between the remote rendering service receiver and the application has been established, the server transmits the OpenGL commands to the client according to the Internet communication protocol.

8. A remote rendering method based on a virtual mobile architecture, comprising:
transmitting a plurality of OpenGL commands to a remote rendering service sender through a QEMU pipe;
transmitting the OpenGL commands to a client through an Internet communication protocol by the remote rendering service sender;
receiving the OpenGL commands through the client executing a remote rendering service receiver;
after a connection between the remote rendering service receiver and an application is established, drawing a screen corresponding to the application according to the OpenGL commands; and
displaying the screen at the client.

9. The remote rendering method based on a virtual mobile architecture according to claim 8, further comprising:
establishing the Internet communication protocol with the client; and
establishing a picture transfer protocol between the remote rendering service receiver and the application.

10. The remote rendering method based on a virtual mobile architecture according to claim 9, wherein the client executes the remote rendering service receiver according to the Internet communication protocol to receive the OpenGL commands.

11. The remote rendering method based on a virtual mobile architecture according to claim 10, wherein when the OpenGL commands are transmitted to the client, whether there are data in a buffer is confirmed through the Internet communication protocol, and if it is confirmed that there are no data in the buffer, the OpenGL commands are continuously transmitted, and whether there are data in the buffer is continuously confirmed.

12. The remote rendering method based on a virtual mobile architecture according to claim 11, wherein if it is confirmed that there are data in the buffer, whether the connection between the remote rendering service receiver and the application has been established is confirmed according to the picture transfer protocol.

13. The remote rendering method based on a virtual mobile architecture according to claim 11, wherein if it is confirmed that the connection between the remote rendering service receiver and the application has not been established, the picture transfer protocol connecting the remote rendering service receiver and the application is re-established.

14. The remote rendering method based on a virtual mobile architecture according to claim 11, wherein if it is confirmed that the connection between the remote rendering service receiver and the application has been established, the OpenGL commands are transmitted to the client according to the Internet communication protocol.

15. A remote rendering device based on a virtual mobile architecture, comprising:
a central processing unit, used to execute a remote rendering service receiver to receive a plurality of OpenGL commands from a server;
a graphics processing unit, coupled to the central processing unit, used to draw a screen corresponding to the application according to the OpenGL commands after a connection between the remote rendering service receiver and the application has been established; and
a display, coupled to the graphics processing unit, used to display the screen.

16. The remote rendering device based on a virtual mobile architecture according to claim 15, wherein the server establishes an Internet communication protocol with the central processing unit, and establishes a picture transfer protocol between the remote rendering service receiver and the application.

17. The remote rendering device based on a virtual mobile architecture according to claim 16, wherein the central processing unit executes the remote rendering service receiver according to the Internet communication protocol to receive the OpenGL commands.

18. The remote rendering device based on a virtual mobile architecture according to claim 17, further comprising:
a buffer, coupled to the central processing unit;
wherein if there are data in the buffer, the server confirms whether a connection between the remote rendering service receiver and the application has been established according to the picture transfer protocol.

19. The remote rendering device based on a virtual mobile architecture according to claim 18, wherein if the server confirms that the connection between the remote rendering service receiver and the application has not been established, the client re-establishes the connection between the remote rendering service receiver and the application according to the picture transfer protocol.

20. The remote rendering device based on a virtual mobile architecture according to claim 19, wherein if the server confirms that the connection between the remote rendering service receiver and the application has been established, the client transmits the OpenGL commands to the central processing unit according to the picture transfer protocol.
